(19) United States
(12) Patent Application Publication
(10) Pub. No.: US 2007/0279465 A1
(43) Pub. Date: Dec. 6, 2007

(54) Ink-jet printer and recording head

(75) Inventor: Tatsuya Shindo, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 11/810,426

(22) Filed: Jun. 5, 2007

(30) Foreign Application Priority Data
Jun. 6, 2006 (JP) 2006-156930

(51) Int. Cl. B41J 2/18

(52) U.S. Cl. 347/89

(57) ABSTRACT

An ink-jet printer includes a recording head which has a first nozzle, and a second nozzle having a hole diameter larger than a hole diameter of the first nozzle, an ink cartridge which supplies an ink to the first nozzle, a reusable-ink tank device which stores for reusing a waste ink discharged from the first nozzle for a recovery of the ink from the first nozzle, and a supply passage which supplies the waste ink from the reusable-ink tank device to the second nozzle. Accordingly, it is possible to perform the printing effectively, without allowing the reusable ink blocked in the nozzle.

### CROSS-REFERENCE TO RELATED APPLICATION

The present application claims priority from Japanese Patent Application No. 2006-156930, filed on Jun. 6, 2006, the disclosure of which is incorporated herein by reference in its entirety.

### BACKGROUND OF THE INVENTION

1. Field of the Invention

The present invention relates to a mechanism, in an ink-jet printer, to reuse for printing, a waste ink which is discharged for recovering an ink-discharge function of a nozzle, and a recording head which is used in the ink-jet printer.

2. Description of the Related Art

In a recording head of an ink-jet printer which performs printing on a recording medium by jetting an ink from a plurality of nozzles, sometimes, jetting quality is affected by blocking of nozzles due to mixing of air in the ink, or thickening of the ink remained in the recording head. Therefore, in the ink-jet printer, in order to recover the jetting quality by eliminating the blocking of the nozzle, so-called maintenance operations such as a suction purge in which the ink is sucked from the nozzle, and/or a flushing operation in which the ink is discharged forcibly or intentionally, are performed. In such maintenance operations, there has been a problem that a large amount of ink is consumed wastefully.

Therefore, attempts have hitherto been made for printing by reusing a waste ink discharged by the maintenance operations. In an ink-jet printer disclosed in Japanese Patent Application Laid-open No. 2004-136482, the waste ink discharged in the maintenance operations is stored in a waste-ink tank provided with a liquid-amount sensor. When a predetermined amount of the waste ink is stored, the waste ink is jetted forcibly from a special head in black printing. Also in an ink-jet recording apparatus described in Japanese Patent Application Laid-open No. 2003-205635, a head for reusable ink is provided. Moreover, a waste-ink tank which stores a light-black color ink of mixture of sucked inks of three colors other than black color is also provided. Almost the same amount of each ink from a plurality of color inks is sucked and mixed, and almost uniform light-black color ink is prepared. The light-black color ink is jetted as a reusable ink. Moreover, in Japanese Patent Application Laid-open No. 2003-334972, an ink-jet recording means including a recording head which jets an ink by using thermal energy is disclosed. At the time of reusing a waste ink, discharge conditions such as a power-distribution time, and drive voltage are changed. A control is made to select as to whether the reusable ink is to be used or not, and a reusable ink mode and a normal printing mode are used appropriately.

An ink-jet printer in which the waste ink is reused as mentioned above is capable of using the waste ink discharged by the maintenance operation effectively. However, in the waste ink such as disclosed in Japanese Patent Application Laid-open No. 2003-334972, as compared to a normal ink, air and impurities are mixed, and the ink is in the thickened form. Consequently, thickened ink, air, and impurities tend to be blocked in the nozzles for jetting the reusable ink, and the printing quality is declined. Therefore, discharging the reusable ink stably and effectively to perform an effective printing operation has been an issue.

### SUMMARY OF THE INVENTION

An object of the present invention is to perform an effective printing operation by jetting stably and effectively a reusable ink, by preventing blocking of a nozzle due to printing discharge in which the reusable ink is used. Reference numerals in brackets which are assigned to each components shown below are mere exemplifications, and do not restrict each of the components.

According to a first aspect of the present invention, there is provided an ink-jet printer (1) including a recording head (9) having a first nozzle (12B, 12C, 12Y, or 12M) which jets an ink, and a second nozzle (12R) which has a hole diameter greater than a hole diameter of the first nozzle, an ink cartridge (2B, 2C, 2Y, or 2M) which supplies the ink to the first nozzle, a reusable-ink tank device (2R) which stores a waste ink discharged from at least the first nozzle for a recovery of the first nozzle to reuse the waste ink, and a supply passage (6R) which supplies the waste ink from the reusable-ink tank device to the second nozzle; and the waste ink is supplied to the second nozzle from the reusable-ink tank device via the supply passage.

In the ink-jet printer of the present invention, the reusable ink in a thickened form is jetted from the second nozzle having a large hole diameter. Therefore, it is possible to prevent the reusable ink from being blocked in the nozzle, and to prevent a decline in a printing quality. Generally, when there is an increase in a viscosity of the ink, there is also an increase in a channel resistance in an ink channel, due to which a supply of the ink is not sufficient, and a continuous jetting becomes impossible. A factor which affects the channel resistance of the ink channel to the maximum extent is a hole diameter of the nozzle. Consequently, by making larger the hole diameter of the second nozzle, it is possible to suppress an increase in the channel resistance, and the continuous jetting of the ink from the second nozzle also becomes possible. Furthermore, a size of a droplet of the reusable ink jetted from the second nozzle having the larger diameter becomes large. Therefore, it is possible to use for a printing mode such as a facsimile, a draft printing, and a text printing, in which an image quality is irrelevant, and it is possible not only to reuse the waste ink effectively, but also to suppress a consumption of a normal ink.

In the ink-jet printer (1) of the present invention, the first nozzle may have a nozzle (12B) which jets a black ink, and a nozzle (12C, 12Y, or 12M) which jets a color ink; and the reusable-ink tank device (2R) may store a mixed black ink containing the waste ink discharged from the first nozzle. By using the mixed black ink in the second nozzle, for the printing in which the image quality is irrelevant, it is not only possible to use the waste ink of each color effectively, but also to suppress the consumption of the normal black ink.

The ink-jet printer (1) of the present invention, may further include a waste-ink tank (77) which stores an ink including a waste ink discharged from the second nozzle (12R) for recovery of the second nozzle, and a switching valve (76) which guides the waste ink discharged from the first nozzle and the waste ink discharged from the second nozzle selectively to the reusable-ink tank device (2R) and the waste ink tank. In this case, it is possible to store the reusable waste ink discharged from the first nozzle, and the waste ink discharged from the second nozzle which is not to be reused separately.

The ink-jet printer (1) of the present invention may further include a controller (91) which switches the switching valve (76), and the reusable-ink tank device (2R) may have a waste-ink remainder detector (71, 72) which detects a remaining amount of the waste ink in the reusable-ink tank device (2R), and when the waste-ink remainder detector detects the reusable-ink tank device to be filled with the waste ink, the controller switches the switching valve to guide the ink discharged from the first nozzle (12B, 12C, 12Y, or 12M) and the ink discharged from the second nozzle (12R) to the waste-ink tank (77). In this case, it is possible to store the reusable ink effectively to maintain the reusable ink in a state in which it is possible to discharge the reusable ink.

The ink-jet printer (1) of the present invention may further include a suction device (60) which sucks from the first nozzle (12B, 12C, 12Y, or 12M) and the ink from the second nozzle (12R), the ink for the recovery of the first and second nozzles respectively, and the suction device (60) may have a cap (61) which covers the first nozzle and the second nozzle, a suction pump (65) which is connected to the cap, and which sucks the ink in the first nozzle and the ink in the second nozzle, and a second switching valve (64) which is switched selectively to suck the ink from the first nozzle and the ink from the second nozzle. In this case, it is possible to suck and discharge the ink respectively from the first nozzle and the second nozzle.

In the ink-jet printer (1) of the present invention, the cap (61) may be divided to be capable of sucking the ink from the first nozzle (12B, 12C, 12Y, or 12M) and the ink from the second nozzle (12R) separately. In this case, it is possible to suck and store separately the waste ink which can be reused, and the thickened waste ink which is not to be reused.

The ink-jet printer (1) of the present invention, may further include a controller (91) which controls the recording head (9) to switch between a mode of printing by using only the ink from the ink cartridge (2B, 2C, 2Y, or 2M), and a mode of printing by using the waste ink of the reusable-ink tank device (2R), and the controller, in the mode of printing by using the waste-ink of the reusable-ink tank device adjusts a frequency of a printing pulse for jetting the ink is to be lower, and adjusts a drive voltage for jetting the ink to be higher than in the mode of printing by using only the ink from the ink cartridge. In this case, it is possible to jet stably the thickened reusable ink. Also, splashing of ink at the time of jetting becomes less, and it is possible to stabilize landing of the jetted ink on a recording medium.

In the ink-jet printer (1) of the present invention, the ink cartridge (2B, 2C, 2Y, or 2M) may have an ink remainder detector (73) which detects an amount of ink remained in the ink cartridge, and when the ink remainder detector detects the amount of ink in the ink cartridge to be small, the recording head (9) performs printing by jetting the waste ink supplied from the reusable-ink tank device (2R) to the second nozzle (12R). In this case, by using the reusable ink effectively, it is possible to avoid a situation in which the printing is impossible due to the ink in the ink cartridge getting exhausted.

The ink-jet printer (1) of the present invention may further include an input device (84) via which a user selects a mode of using the waste ink of the reusable-ink tank device (2R), when the recording head (9) performs printing by jetting the ink. In this case, the user is capable of printing by selecting an ink according to the printing quality of the printing medium, and to suppress a wasteful consumption of the ink.

According to a second aspect of the present invention, there is provided a recording head (9) which jets an ink, which includes a first nozzle (12B, 12C, 12Y, or 12M) and a second nozzle (12R) which jets the ink, and a hole diameter of the second nozzle (12R) may be greater than a hole diameter of the first nozzle, and the second nozzle may jet a recovered ink which is recovered from the first nozzle.

According to the recording head of the present invention, since a reusable ink in a thickened form is recovered from the first nozzle, and is jetted from the second nozzle having the greater hole diameter, it is possible to prevent the reusable ink from being blocked in the second nozzle. Therefore, it is possible to prevent a decline in a printing quality. Generally, when there is an increase in a viscosity of the ink, there is also an increase in a channel resistance in an ink channel, due to which a supply of the ink is not sufficient, and a continuous jetting becomes impossible. A factor which affects the channel resistance of the ink channel to the maximum extent is a hole diameter of the nozzle. Consequently, by making the hole diameter of the second nozzle to be greater, it is possible to suppress an increase in the channel resistance, and the continuous jetting of the ink from the second nozzle also becomes possible. Furthermore, a size of a droplet of the reusable ink jetted from the second nozzle having the greater diameter becomes large. Therefore, it is possible to use the reusable ink for a printing mode such as a facsimile, a draft printing, and a text printing, in which an image quality is irrelevant, and it is possible not only to reuse the waste ink effectively, but also to suppress a consumption of a normal ink.

In the recording head (9) of the present invention, the first nozzle may include a nozzle (12B) which jets a black ink, and a nozzle (12C, 12Y, or 12M) which jets a color ink.

In the recording head (9) of the present invention, the second nozzle may jet a mixed black ink which contains the recovered ink recovered from the first nozzle(s).

The recording head (9) of the present invention may further include a first ink chamber (a plurality of first ink chambers (14B, 14C, 14Y, or 14M) which stores the ink to be supplied to the first nozzle (12B, 12C, 12Y, or 12M), and a second ink chamber (14R) which stores the recovered ink which is recovered from the first nozzle(s), and the second nozzle (12R) may communicate with the second ink chamber. Since the ink stored in the second ink chamber is recovered from the first nozzle, impurities or the like may be mixed in the ink, and a viscosity may be increased. Since the hole diameter of the second nozzle which jets this ink is large, it is possible to prevent the blocking of the ink in the second nozzle, and to jet the reusable ink efficiently.

The recording head (9) of the present invention may further include a first ink supply hole (29B, 29C, 29Y, or 29M) which communicates the first ink chamber (14B, 14C, 14Y, or 14M) and first nozzle (12B, 12C, 12Y, or 12M), and a second ink supply hole (29R) which communicates the second ink chamber (14R) and the second nozzle (12R), and a hole diameter of the second ink supply hole is greater than a hole diameter of the first ink supply hole. Since the ink stored in the second ink chamber is recovered from the first nozzle, impurities or the like may be mixed in the ink, and a viscosity may be increased. Since the hole diameter of the second nozzle which jets this ink is large, it is possible to prevent the blocking of the ink in the second nozzle, and to jet the reusable ink efficiently.

### BRIEF DESCRIPTION OF THE DRAWINGS

FIG. 1 is schematic view of an ink-jet printer which is an embodiment of the present invention;

FIG. 2 is a cross-sectional perspective view showing a structure of a recording head 9;

FIG. 3 is a diagram of a nozzle plate 21 when viewed from below;

FIG. 4 is a diagram showing an electrical structure of the ink-jet printer 1 of the embodiment;

FIG. 5 is a diagram showing an electrical structure of a driving circuit 49;

FIG. 6 is a flowchart showing a printing operation in which a reusable ink of this embodiment is used; and

FIG. 7 is a flowchart showing a printing operation in which a reusable ink of the other embodiment is used.

### DETAILED DESCRIPTION OF THE PREFERRED EMBODIMENTS

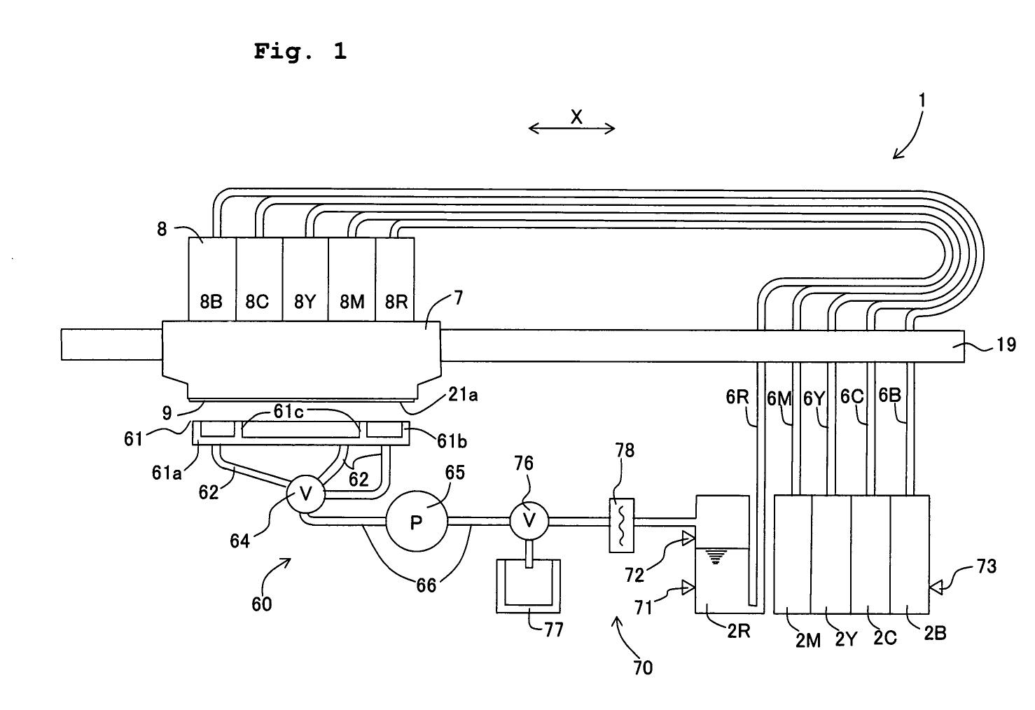

An embodiment of the present invention will be described below by referring to the accompanying diagrams. In the following description, a side (direction) of jetting an ink from a nozzle on to a recording paper is let to be downward direction and a lower side, and a side opposite to this side is let to be an upward direction and an upward side. A scanning direction (X direction) of a carriage 7 in FIG. 1 is let to be a left and right direction. Moreover, for showing inks of different colors, a black ink is shown as B, a cyan ink is shown by C, a yellow ink is shown by Y, a magenta ink is shown by M, and a reusable ink is shown by R.

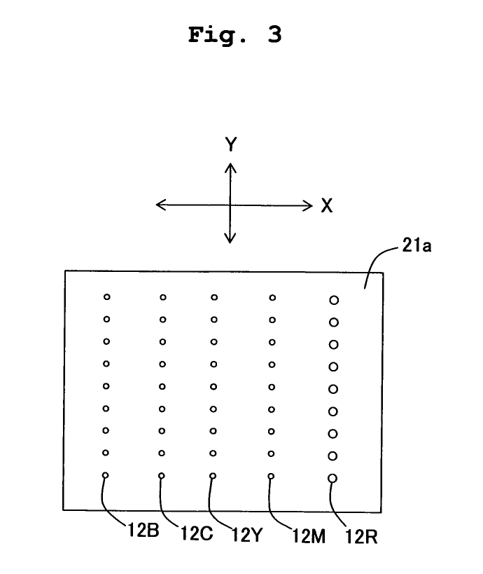

The ink-jet printer 1 of the present invention will be described by using FIG. 1. The ink-jet printer 1 includes a substantially box-shaped head holder 7 which is slidably installed on a guide shaft 19. The head holder 7 is provided with a function as a carriage. A recording head 9 which is provided with a plurality of nozzles 12 (FIG. 3) jetting the ink is arranged on a bottom surface of the head holder 7. A plurality of buffer tanks 8 is mounted on a farther upper side of the head holder 7, and each ink of an ink cartridge 2 is stored therein. Inks in the buffer tanks 8 are supplied to the nozzles of the recording head 9 respectively, according to the color. Printing is performed on a recording medium by jetting the ink from the nozzles, while the head holder 7 moves in the scanning direction (left and right direction, X direction) along the guide shaft 19.

The ink cartridge 2 includes ink cartridges 2B, 2Y, 2C, and 2M (2B to 2M) which store normal inks of black B, yellow Y, cyan C, and magenta M colors, and a reusable-ink cartridge (reusable-ink tank device) 2R which stores a mix-black ink of the reusable ink which will be described later. One end of each of a plurality of ink supply tubes 6B, 6Y, 6C, and 6M (6B to 6M) is connected to each of the ink cartridges 2B to 2M respectively, and the other end of each of the ink supply tubes 6B to 6M is connected the buffer tanks 8B to 8M of respective inks. Each of the inks is supplied from the ink cartridge 2 to the buffer tank 8. Moreover, a sensor (ink remainder detector) 73 which detects a remainder of ink is installed on each of the ink cartridges 2B to 2M of the ink cartridge 2. In FIG. 1, the sensor 73 is shown only for the ink cartridge 2B for the black ink.

The reusable-ink cartridge 2R is a storage device for reusing waste ink which is sucked from the nozzles 12 by a suction device 60 which will be described later. The reusable-ink cartridge 2R, similarly as the ink cartridges 2B to 2M, is connected to the one end of the ink supply tube (in supply passage) 6R. The other end of the ink supply tube 6R is connected to the buffer tank 8R for the reusable ink. Accordingly, the reusable ink is supplied from the reusable-ink cartridge 2R to the buffer tank 8R. A remainder detecting sensor 71 which detects the reusable ink, and a sensor 72 which detects whether the reusable-ink cartridge 2R is filled with the reusable ink are installed in the reusable-ink cartridge 2R. These sensors 71 and 72 (waste-ink remainder detectors) will be described later in detail. Moreover, the buffer tank 8 is structured to include the buffer tanks 8M to 8B, and 8R integrally, or to be detachable.

At one end in the left and right direction of the ink-jet printer 1, and in a downward direction (lower side) of the guide shaft 19, the suction device 60 which performs a suction purge by sucking the ink in the nozzle is arranged for restoring an ink discharge from malfunctioning. At the time of sucking the ink inside the nozzle, the ink is sucked from the nozzle 12 of the recording head 9, with the head holder 7 moved up to a position at which the suction device 60 is arranged as shown in FIG. 1. A part of the sucked ink (waste ink) is reused as reusable ink. It is not shown in the diagram, but a known wiper which cleans by wiping a nozzle surface of the recording head 9 is arranged beside the suction device 60. Moreover, a flushing receiver not shown in the diagram, is arranged at the other end of the ink-jet printer 1, which restores the ink discharge from the malfunction, by jetting the ink periodically or forcibly from the nozzle 12 of the recording head 9. The suction device 60 will be described later in detail.

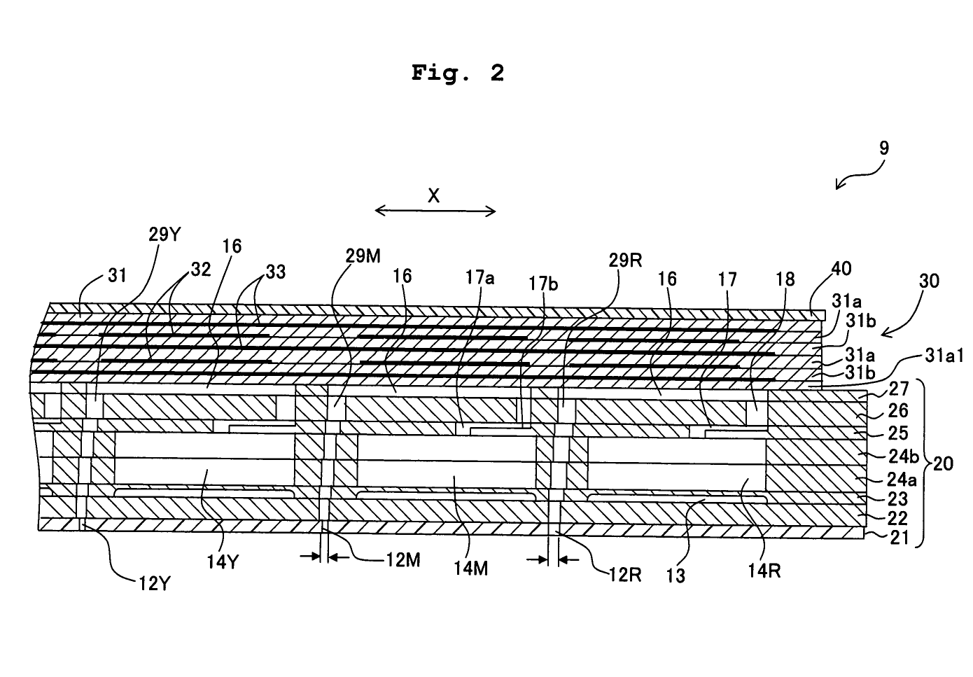

The head holder 7 has a bottom surface opened, and the recording head 9 arranged at a bottom portion has the nozzle 12 arranged on a lowest surface exposed on the opened surface 21 of the head holder 7. The recording head 9 has a structure as described in Japanese Patent Application Laid-open No. 2005-322850, and is formed by stacking and adhering a plurality of plates as shown in FIG. 2. In the recording head 9, a cavity plate 20 having a nozzle plate 21 at the lowest surface, and a piezoelectric actuator 30 in a form of a plate having a piezoelectric deforming portion which applies selectively a jetting pressure to the ink in the cavity unit 20 are adhered, and a flexible wire material 40 on which a driving circuit 49 is mounted is joined on an upper surface thereof. The driving circuit 49 transmits printing data to the piezoelectric actuator 30 and drives the piezoelectric actuator 30, thereby makes the ink to be jetted.

The cavity unit 20 is formed by stacking and joining by an adhesive in all eight thin plates namely the nozzle plate 21, a spacer plate 22, a damper plate 23, two manifold plates 24a and 24b, a supply plate 25, a base plate 26, and a cavity plate 28 from a lower side. In the embodiment, each of the plates 21 to 27 has a thickness of about 50 μm to 150 μm. The nozzle plate 21 is made of a synthetic resin such as polyimide, and the other plates are made of 42% nickel alloy steel plate.

As shown in FIG. 3, in the nozzle plate 21 on the lowest surface of the cavity unit 20, a nozzle 12B for the black ink, a nozzle 12C for the cyan ink, a nozzle 12Y for the yellow ink, and a nozzle 12M for the magenta ink (first nozzle), and a nozzle 12R for the reusable ink (second nozzle) are arranged in a row in a direction (Y direction) orthogonal to the scanning direction (X direction) of the head holder 7, for each color. The nozzle 12R for the reusable ink has a hole diameter greater than a hole diameter the nozzles 12B to 12M for the inks of other colors. In the embodiment, the hole diameter of the nozzles 12B to 12M is about 15 μm to 25 μm, and the hole diameter of the nozzle 12R for the reusable ink is about 25 μm to 30 μm.

Since the reusable ink is waste ink sucked by the suction device 60, air and impurities are mixed in the reusable ink, and is in a thickened condition upon being dried. The nozzle 12R which jets the reusable ink tends to be blocked by the air and the impurities mixed in the ink, and the thickened ink, as compared to the other nozzles 12B to 12M, which sometimes declines the printing quality. Therefore, by letting the hole diameter of the nozzle 12R jetting the reusable ink to be greater than the hole diameter of the normal nozzles 12B to 12M, it is possible to prevent the blocking by the reusable ink. Moreover, generally, when there is an increase in a viscosity of the ink, there is also an increase in a channel resistance in an ink channel, due to which a supply of ink is not sufficient, and a continuous jetting becomes impossible. A factor which affects the channel resistance of the ink channel to the maximum extent is a hole diameter of the nozzle. For example, according to data of experiments carried out by inventors of the present invention, a channel resistance of a nozzle having a hole diameter of 20 μm, with an ink viscosity of 3 mPa·s and a channel resistance of a nozzle having a hole diameter 23.4 μm, with an ink viscosity of 4 mPa·s (about 1.3 times) are same. In other words, even when there is an increase in the viscosity of the ink, by increasing the hole diameter, it is possible to maintain the channel resistance to be the same value. Consequently, by increasing the hole diameter of the nozzle 12R which jets the reusable ink, it is possible to suppress the increase in the channel resistance, and the continuous jetting of the ink from the nozzle 12R which jets the reusable ink also becomes possible. Moreover, a size of a droplet of the reusable ink jetted from the second nozzle having the greater diameter is increased (becomes large). Therefore, for example, it is possible to use for a printing mode such as a facsimile, a draft printing, and a text printing, in which an image quality is irrelevant, and it is possible not only to reuse the waste ink effectively, but also to suppress a consumption of a normal ink. Furthermore, since the reusable ink R is jetted from the nozzle 12R for the reusable ink having the hole diameter greater than the hole diameter of the normal nozzles 12B to 12M, the ink droplet which is jetted becomes larger in size. It is possible to use effectively such reusable ink R in a black and white printing such as the facsimile, the draft printing, and the text printing, in which the image quality is irrelevant.

Moreover, in the cavity plate 27 arranged on the uppermost surface, a row of pressure chambers 16 in which a plurality of pressure chambers 16 corresponding to the nozzles 12 are arranged along the Y direction is formed, and five rows of the pressure chambers 16 are formed in the X direction. In the embodiment, each pressure chamber 16 having a long and slender shape in a plan view is formed through the cavity plate 27, and each pressure chamber 16 is extended such that a long side of the pressure chamber 16 is along the X direction. One end in a longitudinal direction of each pressure chamber 16 communicates with the nozzles 12, and the other end of each pressure chamber 16 communicates with a common ink chamber 14.

Five common ink chambers 14 (14B, 14C, 14Y, 14M, and 14R) are formed in the two manifold plates 24a and 24b. The five common ink chambers 14 penetrate through a plate thickness, and are arranged along each row of the nozzles 12. In other words, in a plan view from a direction of stacking of each plate, each common ink chamber 14 is extended in a direction of the row of the pressure chambers 16, overlapping with a part of the pressure chambers 16. The two manifold plates 24a and 24b are stacked, and the common ink chamber (manifold chamber) 14 is defined by the supply plate 25 which covers an upper surface of the two stacked manifold plates 24a and 24, and by the damper plate 23 which covers the two stacked manifold plates 24a and 24b.

A continuous channel 17 which communicates with the common ink chamber 14, and which supplies the ink to each of the pressure chambers 16 is provided to the supply plate 25. An inlet 17a through which the ink enters from the common ink chamber 14, an outlet 17b which opens in a sideward direction of the pressure chamber 16, and an aperture portion which is formed by reducing a cross-sectional area such that the channel resistance is the maximum between the inlet 17a and the outlet 17b, in the connecting channel 17, are formed in the connecting channel 17. A communicating hole 18 which communicates the outlet 17b and the pressure chamber 16, is formed in the base plate 26. Ink supply holes 29B, 29C, 29Y, 29M, and 29R are provided in each of the plates 22 to 26, so that the ink is supplied from the pressure chamber 16 to the nozzle 12. Since the ink nozzle 12R for the reusable ink is larger than the nozzle for the normal ink, the ink supply hole 29R which communicates with the nozzle 12R for the reusable ink has a diameter greater than a diameter of the other ink supply holes 29B to 29M. Moreover, a damper chamber 13 which is isolated from the common ink chamber 14 is formed in a lower surface side of the damper plate 23. A position and a shape of each damper chamber 13 match with a position and a shape of each common ink chamber 14. It is possible to deform freely a ceiling in a form of a thin plate of the damper chamber 13 toward the common ink chamber 14 and as well as toward the damper chamber 13. Therefore, a damper effect of absorbing and attenuating a pressure fluctuation (pressure change) which is propagated from the pressure chamber 16 at the time of ink discharge is shown, and a cross-talk is prevented.

It is not shown in the diagram, but one end of each of the five common ink chambers 14 communicates one-to-one with each of the buffer tanks 8B to 8M, and 8R, and the inks are supplied to these five common ink chambers 14B to 14M, and 14R respectively. In ink distribution channels from the ink cartridges 2B to 2M, and 2R, up to the nozzles 12B to 12M, and 12R corresponding to each of the colors respectively, the ink is supplied from the ink cartridges 2B to 2M, and 2R to the common ink chambers 14B to 14M, and 14R via the buffer tanks 8B to 8M, and 8R. The ink supplied to the common ink chambers 14B to 14M, and 14R is supplied to each of the pressure chambers 16 via the connecting channel 17 of the supply plate 25. By driving selectively the piezoelectric actuator 30 based on a printing signal from the driving circuit 49, the ink flows from each of the pressure chambers 16 through the ink supply holes 29, and is jetted from the nozzles 12B to 12M, and 12R corresponding to the respective pressure chambers 16.

The piezoelectric actuator 30, similarly to a hitherto known piezoelectric actuator described in Japanese Patent Application Laid-open No. 2005-322850, is formed by baking integrally a plurality of ceramics layers 31 including a lowermost ceramics layer 31a1 covering each of the pressure chambers 16, by stacking the ceramics layers 31 in a direction at right angles to a surface on which the pressure chambers 16 are arranged, from a side of the cavity unit 20. A thickness of a ceramics layer is about 30 μm, and the ceramics layer includes a piezoelectric ceramics such as PZT. On an upper surface (wide surface) of an even numbered ceramics layer 31b from a lower side, from among the ceramics layers, an individual electrode 32 having a shape almost same as a shape of the pressure chamber 16 is formed at each location corresponding to each pressure chamber 16 in the cavity unit 20. Moreover, on an upper surface (wide surface) of an odd numbered ceramics layer 31a from the lower side, a common electrode 33 is formed corresponding to the plurality of pressure chambers 16. The common electrode 33 is connected to a ground electric potential. The individual electrode 32 and the common electrode 33 are arranged alternately, sandwiching at least one ceramics layer, excluding the lowermost ceramics layer 31a1, and the individual electrode 32 and the common electrode 33 are facing mutually.

In the piezoelectric actuator 30, each of the individual electrodes 32, and each of the pressure chambers 16 in the cavity unit 20 are arranged face-to-face mutually, and are fixed by adhering on the cavity unit 20. On an uppermost surface of the piezoelectric actuator 30, a connecting terminal which connects electrically with each of the individual electrodes 32 and the common electrode 33 is formed, and is connected to a wiring pattern formed on the flexible wire material 40. In the piezoelectric actuator 30, a portion of the ceramics layer between the common electrode 33 and the individual electrode 32 facing in a direction of stacking of the ceramics layers is let to be an energy generating portion. When the driving circuit 49 applies selectively a voltage between the individual electrode 32 and the common electrode 33, the energy generating portion corresponding to the individual electrode 32 to which the voltage is applied is displaced in the direction of stacking. The displacement of the energy generating portion changes a volume of the pressure chamber 16, and pushes the ink. As a result, the ink flows through the ink supply hole 29 in the cavity unit 20 and is jetted from the nozzle 12, and the printing is performed. When the printing is over the driving circuit 49 stops applying the voltage. At this time, by restoring of the energy generating portion from the displaced state, the volume of the pressure chamber 16 is restored. Accordingly, the ink is supplied to the pressure chamber 16 from the ink cartridge 2 via the buffer tank 8 and the common ink chamber 14 in the cavity unit 20. This ink is supplied to the nozzle 12 at the time of the subsequent printing.

The recording head 9 is provided with each nozzle row integrally. However, the recording head 9 may be structured such that an individual unit is formed for each nozzle row, and these individual units are combined.

As shown in FIG. 1, the suction device 60 performs the suction purge from the nozzle 12 of the recording head 9. Moreover, a discharge mechanism 70 which communicates with the suction device 60, and reuses and disposes the waste ink sucked from the nozzle 12 is provided on a downstream side of the suction device 60. The suction device 60 includes a suction cap (cap) 61 of an elastic body covering a nozzle surface 21a of the recording head 9, and a second switching valve 64 communicating from a discharge port (not shown in the diagram) provided on a bottom of the suction cap 61 via a suction tube 62, and a suction pump 65 which communicates with a downstream side of the second switching valve 64.

The suction cap 61 is provided with a lip portion 61b which is substantially rectangular shaped, surrounding all the nozzle rows 12B to 12M, and 12R in FIG. 3, and which is erected surrounding a bottom portion 61a and a peripheral portion of a bottom portion 61a. Moreover, partition lips 61c which divides the row of nozzles 12B for the black ink, the row of nozzles 12M to 12Y for the color inks, and the row of nozzles 12R for the reusable ink are provided on an inner side of the lip portion 61b. In this manner, the suction cap 61 may be formed by integrating materials (members) each having an independent cap function, into one member, and it is also possible to form each cap as a separate component. The second switching valve 64 is controlled and switched by a microcomputer (controller) 91 which will be described later, such that each space divided inside the suction cap 61 communicates selectively with the suction pump 65 via a waste-ink supply passage 66.

At the time of sucking the ink, an ascending device which is not shown in the diagram, makes the partition lip 61c and the lip portion 61b of the suction cap 61 to ascend, and brings in a close contact with the nozzle surface 21a. Accordingly, the suction cap 61 is in a state of being capable of suction. By communicating any space divided inside the suction cap 61 with the suction pump 65 by switching the second switching valve 64, it is possible to suck selectively the ink from the row of the nozzles 12B for the black ink, the row of the nozzles 12M to 12Y for the color inks, and the row of the nozzles 12R for the reusable ink. Moreover, when the suction is not performed, the lip portion 61 is brought in a close contact with the nozzle surface 21a, and the second switching valve 64 is switched to a state which does not communicate any of the spaces in the suction cap 61 with the suction pump 65. By doing so, an evaporation of ink is prevented, and an ink meniscus is preserved.

Moreover, the discharge mechanism 70 which is provided on a downstream side of the suction pump 65 via the waste-ink supply passage 66 includes a switching valve 76 which classifies the waste ink sucked by the suction device 60 as the ink to be reused and the ink to be disposed, a waste-ink storage (waste-ink tank) 77 which is known and which stores the ink to be disposed, and a filter 78 which removes impurities or the like in the reusable ink. The ink which has passed through the filter 78 is stored in the reusable-ink cartridge 2R which is a reusable-ink storage mentioned above.

The switching valve 76 is controlled by the microcomputer 91 which will be described later, and is a valve which switches to whether the waste ink sucked by the suction device 60 is to be reused or disposed. In a case of reusing the waste ink, the switching valve 76 is switched to guide the ink for storing from the waste-ink supply passage 66 to the reusable-ink cartridge 2R. On the other hand, in a case of disposing the ink, the switching valve 76 is switched to guide to the waste-ink storage 77. Moreover, even in a case in which the waste ink which is reusable is discharged, when the sensor 72 of the reusable-ink cartridge 2R makes a judgment that the reusable-ink cartridge 2R is full (detects the reusable-ink cartridge 2R to be full), the switching valve 76 is switched such that the waste ink is disposed to the waste-ink storage 77.

The reusable ink in this embodiment is a mix black ink which is obtained by mixing the ink sucked by the suction device 60 from the nozzles 12B to 12M which jet the normal ink, the black ink, the yellow ink, the cyan ink, and the magenta ink. The waste ink discharged from the nozzle 12R which jets the reusable ink is disposed without being reused as it is substantially thickened. In other words, normally, the second switching valve 64 is controlled to be switched to suck the nozzles 12M to 12Y, or 12B, and the switching valve 76 is controlled to be switched to guide the waste ink to the reusable-ink cartridge 2R. Moreover, when the ink is about to be discharged from the nozzle 12R for the reusable ink, the second switching valve 64 is controlled to be switched to suck the nozzle 12R, and the switching valve 76 is controlled to be switched to guide the waste ink to the waste-ink storage 77.

It is possible to receive the ink which is subjected to a preparatory jetting by driving the recording head 9 irrespective of the printing operation, or the ink discharged by flushing in the suction cap 61 or another receptacle, and to store in the reusable-ink cartridge 2R as mentioned above, or to guide (direct) to the waste-ink storage 77. Moreover, by providing the suction cap 61, the waste-ink passage 66, the reusable-ink cartridge 2R, and a nozzle of a large diameter for the ink of each color, it is also possible to reuse the ink for each color. Furthermore, it is also possible to store in the reusable-ink cartridge 2R only the black ink discharged from the nozzle 12B for the black ink, and to reuse only this waste ink (black ink). When it is a mode in which an image quality is irrelevant, the waste ink discharged from the nozzle 12R for the reusable ink, though in a thickened state, may not be disposed, but reused.

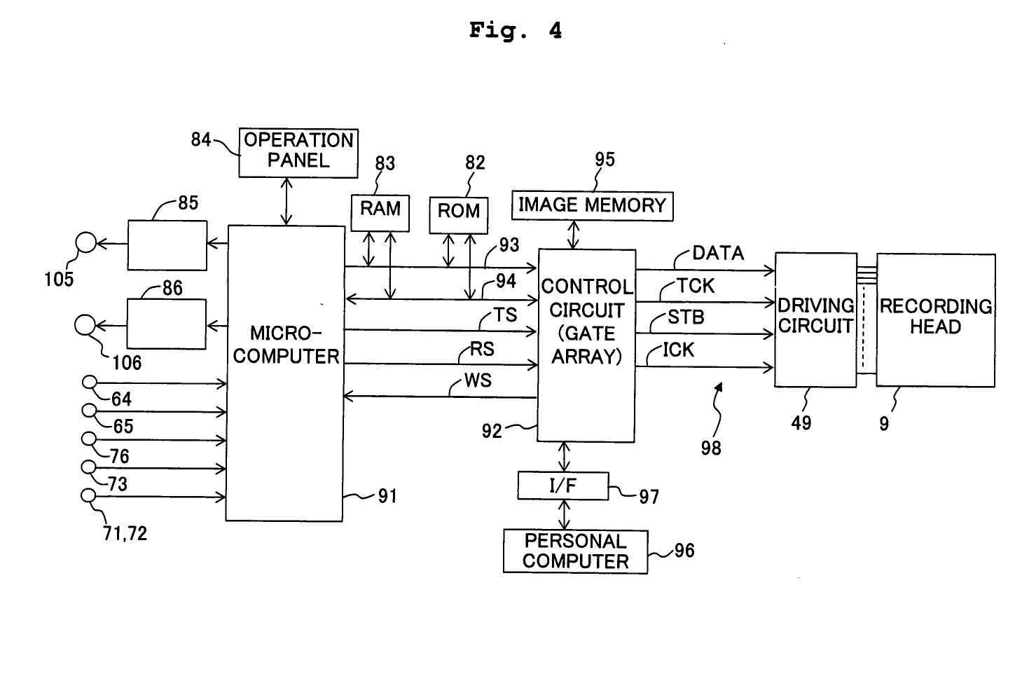

Next, an electrical structure of the ink-jet printer 1 of the embodiment will be described by referring to FIG. 4. FIG. 4 is a block diagram showing the electrical structure of the ink-jet printer 1. A control unit of the ink-jet printer 1 includes the one-chip microcomputer (hereinafter called as ‘CPU’) 91 which controls each section of the ink-jet printer 1, a control circuit 92 which is a gate circuit LSI, a ROM 82 in which printing waveform signals and control programs for discharging various types of inks are stored, and a RAM 83 which temporarily stores data. An operation panel (input device) 84 for inputting various commands, a motor driver 85 which drives a carriage motor 105 which performs reciprocal scanning (movement) of the head holder 7, and a motor driver 86 which drives a transporting motor 106 which driving a transporting device for a recording medium are connected to the CPU 91. Moreover, the switching valve 76, the second switching valve 64, the suction pump 65, the (ink-cartridge remainder) sensor 73 which detects whether there is ink remained in the ink cartridge 2, and the sensors 71 and 72 which detects a remaining amount of the reusable ink of the reusable-ink cartridge 2R are connected to the CPU 91.

The CPU 91, the ROM 82, the RAM 83, and the control circuit 92 are connected via an address bus 93 and a data bus 94. Moreover, the CPU 91 generates a printing timing signal TS and a control signal RS in accordance with a computer program stored in advance in the ROM 82, and transfers the signals TS and RS to the control circuit 92. The control circuit 92, stores in an image memory 95 printing data which is transferred from an external equipment such as a personal computer 96, via an interface 97. Moreover, the control circuit 92 generates a reception interrupt signal WS from the data which is transferred from the personal computer 96 or the like via the interface 97, and transfers the reception interrupt signal WS to the CPU 91. The control circuit 92, in accordance with the printing timing signal TS and the control signal RS, generates a printing data signal DATA, a transfer clock TCK which is synchronized with the printing data signal DATA, a strobe signal STB, and a printing waveform signal ICK, based on the printing data stored in the image memory 95, and transfers these signals DATA, TCK, STB, and ICK to the driving circuit 49.

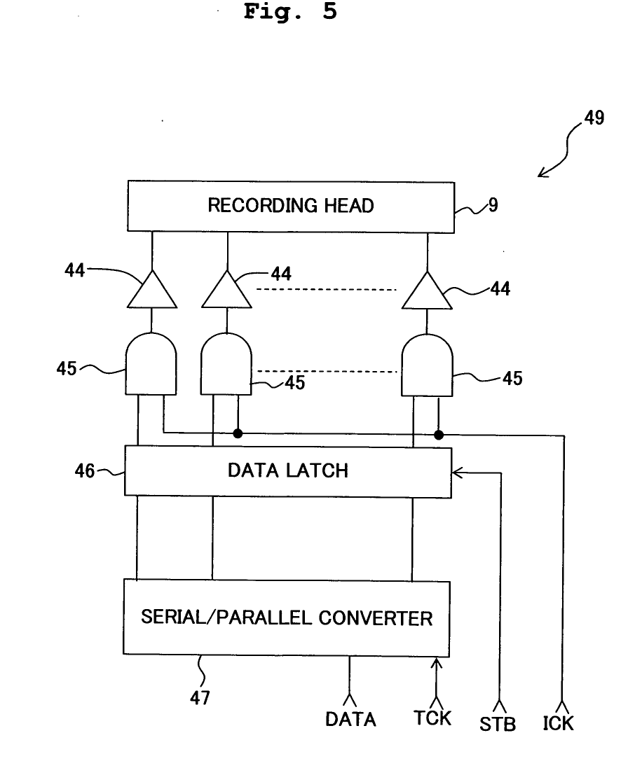

FIG. 5 is a diagram showing an internal structure of the driving circuit 49. The driving circuit 49 includes a serial-parallel converter 47, a data latch 46, an AND gate 45, and a driver 44. The serial-parallel converter 47 converts to parallel data, the printing data signal DATA which is subjected to serial transfer in synchronization with the transfer clock signal TCK from a data transferring section (not shown in the diagram) in the control circuit 92. The data latch 46 latches this parallel DATA which is converted, based on the strobe signal STB. The AND gate 45 outputs selectively the printing waveform signal ICK based on this parallel data. The driver 44 converts the printing waveform signal which is output, to a voltage suitable for the piezoelectric actuator 30, and outputs as a printing pulse. The printing pulse output from the driver 44 is applied to the individual electrode 32 of the recording head 9, and displaces the piezoelectric actuator 30. The number of the serial-parallel converters 47, the data latches 46, the AND gates 45, and the drivers 44 matching with the number of nozzles of the recording head 9 is prepared.

The printing waveform signal for jetting the ink is stored in the ROM 82. The ink is jetted by using this printing waveform signal. A printing operation for jetting the ink will be described below. When a print command is input, an operation for printing the printing data of one line stored in the image memory 95 is started, and the head holder 7 is subjected to scanning (movement) in the left and right direction along the recording medium, upon being driven by the carriage motor 105. The printing data stored in the image memory 85 is read as the printing data signal DATA, one after another in the scanning direction of the carriage by the control circuit 92, and a drive voltage is applied selectively to the piezoelectric actuator 30 via the driving circuit 49 and the printing is performed. In this manner, the printing operation is repeated one after another in the scanning direction of the carriage till the entire printing data is printed, and the printing operation is terminated.

In a case when the printing operation is performed by using the reusable ink, misdischarge (misfiring) of the reusable ink is prevented by making a diameter of the nozzle 12R which discharge as mentioned above, to be greater than a diameter of the normal nozzles 12B to 12M. Therefore, basically, it is possible to control the printing operation with a common printing pulse and frequency as in case of using the normal ink. However, it is preferable that the printing pulse in a case of using the reusable ink is controlled such that a frequency of the printing pulse is lower, and a drive voltage is higher than in a case of using the normal ink. In other words, in the ROM 82, the printing waveform signal ICK for the printing operation using the ink in the normal ink cartridge, and the printing waveform signal ICK for the printing operation using the reusable ink are stored, and moreover, the control circuit 92 outputs the printing waveform signal ICK with a frequency suitable for both printing operations. Since the reusable ink has impurities and air mixed therein, and is thickened, a voltage for jetting the reusable ink is set to be higher than a voltage for jetting the normal ink. Moreover, when such reusable ink is jetted, splashing or the like is remarkable than for the normal ink, and landing of the reusable ink on a recording medium is declined. Therefore, by lowering the frequency of the printing pulse, it is possible to jet the ink stably.

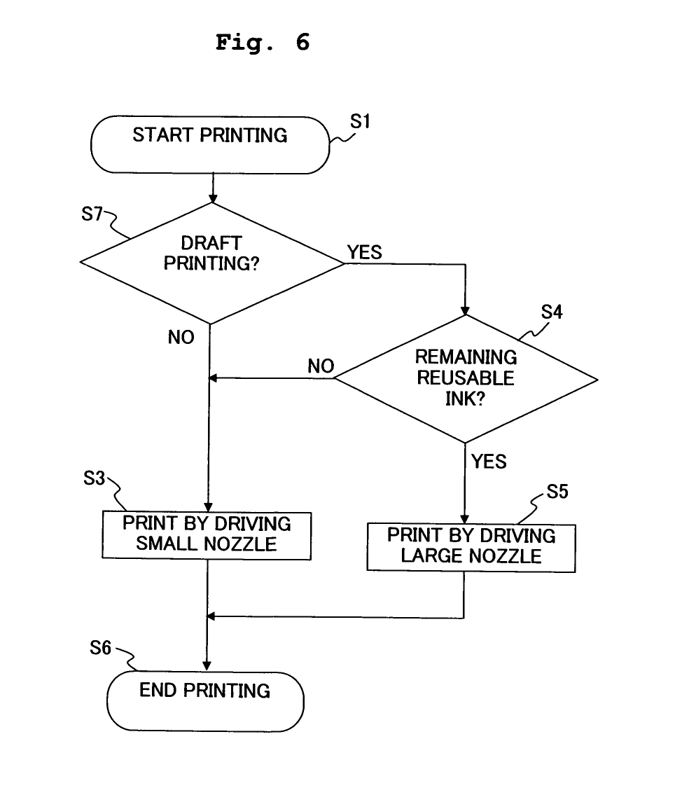

In the printing operation of this embodiment, it is determined whether the printing operation using the normal ink or the printing operation using the reusable ink is to be performed. In other words, as shown in FIG. 6, when the printing command is input (step S1), and none of a printing of a facsimile reception data, a draft printing, and a text printing, but a printing mode of high image quality is selected (NO at step S7), the energy generating portion of the piezoelectric actuator 30 corresponding to the nozzles 12B to 12M having small diameter is driven selectively (step S3), and the printing is performed by consuming the ink in the normal ink cartridges 2B to 2M. When the entire printing data is printed, the printing operation is terminated (step S6). Moreover, in a recovery operation, the second switching valve 64 is switched appropriately to suck the nozzles 12M to 12Y, or 12B. In other words, the suction of the nozzles 12M to 12Y, and the suction of the nozzle 12B are carried out separately. By controlling the switching valve 76 to guide the waste ink to the reusable-ink cartridge 2R, all the waste ink is mixed and stored in the reusable-ink cartridge 2R.

Next, an operation of jetting the reusable ink will be described below. When the printing operation which is commanded is judged to be one of the printing of the facsimile reception data, the draft printing, and the text printing (YES at step S7), a detection of whether the reusable ink is stored or not is made by the remainder detecting sensor 71 provided to the reusable-ink cartridge 2R (step S4). As a result, when the sufficient amount of the reusable ink is stored for discharging the ink, the energy generating portion of the piezoelectric actuator 30 corresponding to the nozzle 12R for the reusable ink having a hole diameter greater than the hole diameter of the normal nozzle is driven (step S5), and the printing is performed by the ink in the reusable-ink cartridge 2R. When the entire printing data is printed, the printing operation is terminated (step S6). Moreover, in the recovery operation, by controlling the second switching valve 64 to suck the ink from the nozzle 12R, and the switching valve 76 to guide the waste ink to the waste-ink storage 77, the waste ink which is discharged in the recovery operation is stored in the waste-ink storage 77. Moreover, when the reusable ink is not stored in the reusable-ink cartridge 2R, the ink is jetted from the nozzle 12B having small diameter, by using the normal black ink.

In this manner, in the printing mode of using the black ink, such as the printing of the facsimile reception data, the draft printing, and the text printing, since the high image quality is not sought, it is possible to maintain a satisfactory finish even by using the reusable ink in which the ink droplets are large. Particularly, since in the draft printing, the printing is performed by reducing dot data at a predetermined interval, the printing result appears to be thinner than the normal case, by jetting the large ink droplet as mentioned above, it is possible to achieve the printing result which is conspicuous. In this case, it is preferable that the frequency of the printing pulse is not lower than a proportion to the reduced dot data with respect to the frequency of the normal printing. In a manner mentioned above, the use of the normal ink and the reusable ink may be selected upon judging a class of the printing data, or may be selected by a button operation on the operation panel 84 or instructions from the personal computer.

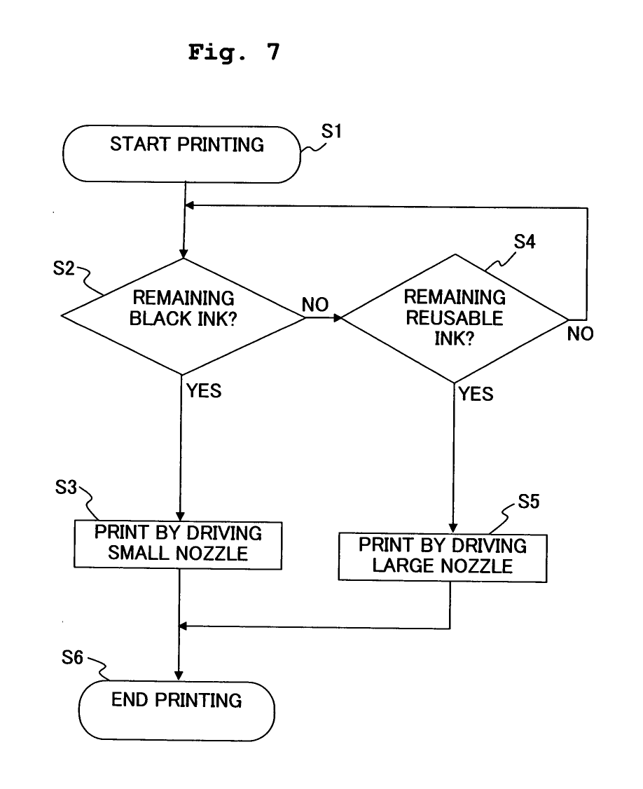

In another embodiment shown in FIG. 7, there is shown an example of a control by selecting the ink to be used for printing according to the remaining amount of the black ink in the ink cartridge 2B for the black ink, in the printing operation of the ink-jet printer 1. When the printing command is input (step S1) and the printing operation as described above is started, a detection of whether the black ink is remained or not is made by the sensor (ink remained detector) 73 of the ink cartridge 2B for black ink (step S2). When the remaining amount of the black ink in the ink cartridge 2B for the black ink is sufficient for the ink jetting, the ink is jetted by using the nozzle 12B having a small hole diameter (step S3), and the printing operation is terminated (step S6). Moreover, when the remaining amount of the black ink is not sufficient for the ink jetting, in order to perform ink jetting by using the reusable ink, a detection of whether the reusable ink is stored or not is made by the remainder detection sensor 71 provided to the reusable-ink cartridge 2R (step S4). As a result, when the reusable ink is stored sufficiently for jetting the ink, the printing is performed by jetting the reusable ink from the nozzle 12R for the reusable ink having the hole diameter greater than the hole diameter of the normal nozzle (step S5), and the printing operation is terminated (step S6). When the reusable ink is not stored sufficiently, a replacement of black-ink cartridge 2B is displayed on the operation panel 84, and the printing is performed after replacing the black-ink cartridge 2B.

In this manner, in the printing operation of the ink-jet printer 1, even when the black-ink cartridge 2B becomes empty upon consuming the normal black ink, since it is possible to perform printing by using the reusable ink, it is possible to use the reusable ink effectively. Moreover, it is preferable to use the printing control as in this embodiment in printing of using the black ink, such as a draft printing mode, and a black and white printing mode as in the facsimile. This series of operations may be carried out by an automatic control. On the other hand, for example, when a judgment is made that there is no remaining ink in the black-ink cartridge 2B (step S2), a replacement of the black-ink cartridge 2B may be displayed on a panel display on an exterior of the ink-jet printer 1. At this time, an arrangement may be made such that the printing by using the reusable ink is performed by selection by a button operation of whether to replace to the new black-ink cartridge 2B, or to jet the ink by using the reusable ink, by the user.

In this manner, in the printing operation using the waste ink which is discharged by a maintenance operation of the ink-jet printer 1, since it is possible to jet the reusable ink in the thickened state, from the nozzle having the large nozzle diameter, the nozzle is not blocked due to the reusable ink, and it is possible to perform stable printing. Moreover, in the printing mode using the reusable ink, since an arrangement is made such that it is possible to jet the thickened ink even under better conditions, by changing printing conditions, it is possible to perform printing effectively by the reusable ink.

The embodiments described above are examples in which the present invention is applied to an ink-jet printer and a recording head. However, embodiments to which the present invention is applicable are not restricted to the embodiments described above. The present invention is not restricted to the ink-jet printer, and is also applicable to apparatuses which are used in various fields such as medical treatment and analysis, provided that it is an apparatus in which it is necessary to reuse droplets recovered from nozzles by a maintenance operation.

What is claimed is:

1. An ink-jet printer comprising:
a recording head having a first nozzle which jets an ink, and a second nozzle which has a hole diameter greater than a hole diameter of the first nozzle;
an ink cartridge which supplies the ink to the first nozzle;
a reusable-ink tank device which stores a waste ink discharged from at least the first nozzle for a recovery of the first nozzle to reuse the waste ink, and
a supply passage which supplies the waste ink from the reusable-ink tank device to the second nozzle;
wherein the waste ink is supplied to the second nozzle from the reusable-ink tank via the supply passage.

2. The ink-jet printer according to claim 1, wherein the first nozzle has a nozzle which jets a black ink, and a nozzle which jets a color ink; and the reusable-ink tank device stores a mixed black ink containing the waste ink discharged from the first nozzle.

3. The ink-jet printer according to claim 1, further comprising a waste-ink tank which stores an ink including a waste ink discharged from the second nozzle for recovery of the second nozzle, and a switching valve which guides the waste ink discharged from the first nozzle and the waste ink discharged from the second nozzle selectively to the reusable-ink tank device and the waste-ink tank.

4. The ink-jet printer according to claim 3, further comprising a controller which switches the switching valve;
wherein the reusable-ink tank device has a waste-ink remainder detector which detects a remaining amount of the waste ink in the reusable-ink tank device, and when the waste-ink remainder detector detects the reusable-ink tank device to be filled with the waste ink, the controller switches the switching valve to guide the ink discharged from the first nozzle and the ink discharged from the second nozzle to the waste-ink tank.

5. The ink-jet printer according to claim 1, further comprising a suction device which sucks the ink from the first nozzle and the ink from second nozzle for recovery of the first and second nozzles respectively;
wherein the suction device has a cap which covers the first nozzle and the second nozzle, a suction pump which is connected to the cap and which sucks the ink in the first nozzle and the second nozzle, and a second switching valve which is switched to selectively suck the ink from the first nozzle and the ink from the second nozzle.

6. The ink-jet printer according to claim 5, wherein the cap is divided to be capable of sucking the ink from the first nozzle and the ink from the second nozzle separately.

7. The ink-jet printer according to claim 1, further comprising a controller which controls the recording head to switch between a mode of printing by using only the ink from the ink cartridge, and a mode of printing by using the waste ink in the reusable-ink tank device;
wherein the controller, in the mode of printing by using the waste-ink of the reusable-ink tank device adjusts a frequency of a printing pulse for jetting the ink to be lower, and adjusts a drive voltage for jetting the ink to be higher than in the mode of printing by using only the ink from the ink cartridge.

8. The ink-jet printer according to claim 1, wherein the ink cartridge has an ink remainder detector which detects an amount of ink remained in the ink cartridge, and when the ink remainder detector detects the amount of ink in the ink cartridge to be small, the recording head performs printing by jetting the waste ink supplied from the reusable-ink tank device to the second nozzle.

9. The ink-jet printer according to claim 1, comprising an input device via which a user selects a mode of using the waste ink in the reusable-ink tank device, when the recording head performs printing by jetting the ink.

10. A recording head which jets an ink, comprising:
a first nozzle and a second nozzle which jet the ink,
wherein a hole diameter of the second nozzle is greater than a hole diameter of the first nozzle, and the second nozzle jets a recovered ink which is recovered from the first nozzle.

11. The recording head according to claim 10, wherein the first nozzle includes a nozzle which jets a black ink, and a nozzle which jets a color ink.

12. The recording head according to claim 10, wherein the second nozzle jets a mixed black ink which contains the recovered ink recovered from the first nozzle.

13. The recording head according to claim 10, further comprising a first ink chamber which stores the ink to be supplied to the first nozzle, and a second ink chamber which stores the recovered ink which is recovered from the first nozzle;
wherein the second nozzle communicates with the second ink chamber.

14. The recording head according to claim 13, further comprising a first ink supply hole which communicates the first ink chamber and the first nozzle, and a second ink-supply hole which communicates the second ink chamber and the second nozzle, and a hole diameter of the second ink-supply hole is greater than a hole diameter of the first ink supply hole.
